(19) United States
(12) Patent Application Publication
(10) Pub. No.: US 2002/0078724 A1
(43) Pub. Date: Jun. 27, 2002

(54) Tail gate locking apparatus for protecting children

(76) Inventor: Jin-Su Choo, Ulsan-shi (KR)

Correspondence Address: BIRCH STEWART KOLASCH & BIRCH, PO BOX 747, FALLS CHURCH, VA, 22040-0747, US

(21) Appl. No.: 09/987,476

(22) Filed: Nov. 14, 2001

(30) Foreign Application Priority Data
Dec. 21, 2000 (KR) 2000-79809

(51) Int. Cl. B60R 25/00

(52) U.S. Cl. 70/237

(57) ABSTRACT

A tail gate locking apparatus whose operational modes can be selectively switched to make an opening of the tail gate possible or impossible from inside the vehicle is disclosed to prevent the tail gate from being dangerously opened by children's wrong manipulation, the apparatus comprising: a base plate; a latch lever rotatively installed at the base plate in connection to a latch device by a latch rod; a control lever rotatively installed at the base plate to rotate the latch lever; an inside lever rotatively installed at the base plate with one side thereof being connected with an inside cable; and rotational force controlling means coupled between the control lever and inside lever to selectively switch a state of unblocking or blocking transmission of rotational force of the inside lever to the control lever.

### BACKGROUND OF THE INVENTION

1. Field of the Invention

The present invention relates to a tail gate locking apparatus to be installed at the rear portion of a vehicle, and more particularly to a tail gate locking apparatus whose operational modes can be selectively switched to make an opening of the tail gate possible or impossible from inside the vehicle to thereby prevent children's wrong manipulation.

2. Brief Description of the Related Art

The conventional tail gate locking apparatus, as shown in FIG. 1, includes outside and inside levers 102, 104 rotatively fixed at a base plate 100 by a pin 106. An outside rod 108 is connected at the outside lever 102 to receive the manipulation force of an outside handle (not shown). On the other hand, an inside cable 110 is connected at the inside lever 104 to receive the manipulation force of an inside handle (not shown), and a latch rod 112 is connected at the inside lever 104 to transmit the manipulation force to a latch device 114.

The tail gate locking apparatus thus constructed can be opened by two manipulating units. When the outside handle positioned at the external side of a vehicle is manipulated to enable the outside rod 108 to rotate the outside lever 102, the outside lever 102 rotates the inside lever 104 to move the latch rod 112 connected thereto to the left of the drawing, thereby unlocking the latch device 114. When the inside cable 110 is pulled by manipulation of the inside handle positioned the internal side of a car body, the inside lever 104 moves the latch rod 112, regardless of the outside lever 102, thereby unlocking the latch device 114.

However, there is a problem in the tail gate locking apparatus thus constructed and operated in that the inside handle can be manipulated in the vehicle to easily open the tail gate, in other words, there has left a possibility of a danger that a child riding close to the tail gate of the vehicle manipulates the inside handle to let the tail gate dangerously open while the vehicle is running.

### SUMMARY OF THE INVENTION

It is an object of the present invention to solve the aforementioned problem and provide a a tail gate locking apparatus whose operational modes can be selectively switched to make an opening of the tail gate possible or impossible from inside the vehicle to thereby prevent the tail gate from being dangerously open by children's wrong manipulation.

In order to accomplish the aforementioned object of the present invention, there is provided a tail gate locking apparatus for protecting children, the apparatus comprising:

a base plate;

a latch lever rotatively installed at the base plate in connection to a latch device by a latch rod;

a control lever rotatively installed at the base plate to rotate the latch lever;

an inside lever rotatively installed at the base plate with one side thereof being connected with an inside cable; and

rotational force controlling means coupled between the control lever and inside lever to selectively switch a state of unblocking or blocking transmission of rotational force of the inside lever to the control lever.

### BRIEF DESCRIPTION OF THE DRAWINGS

For fuller understanding of the nature and object of the invention, reference should be made to the following detailed description taken in conjunction with the accompanying drawings in which:

FIG. 1 is a structural view for illustrating a tail gate locking apparatus of a vehicle in accordance with the prior art;

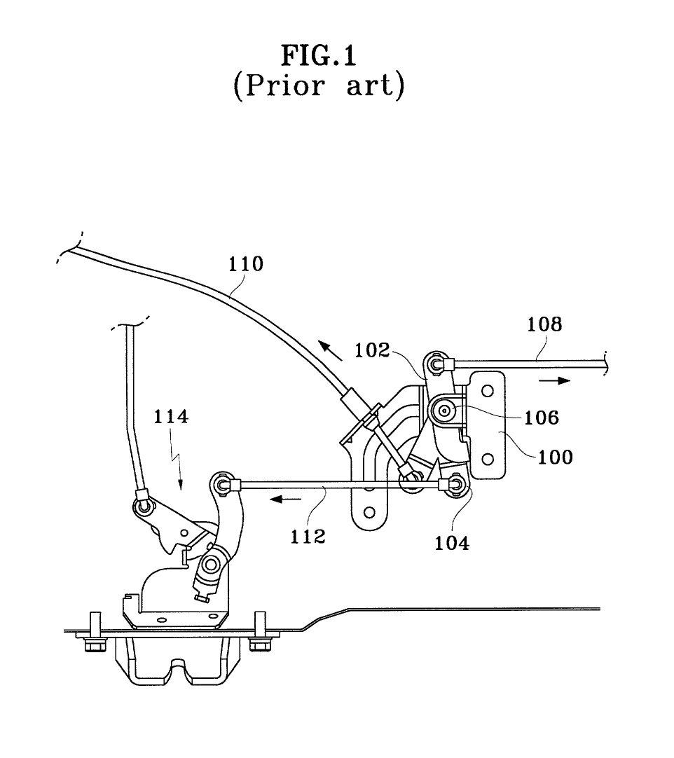

FIG. 2 is a perspective view for illustrating a tail gate locking apparatus for protecting children in accordance with the present invention;

FIG. 3 is a perspective rear view of FIG. 2;

FIG. 4 is a front view for illustrating the structure of FIG. 2;

FIG. 5 is a cross-sectional view taken along line V-V of FIG. 4; and

FIG. 6 is a cross-sectional view taken along line VI-VI of FIG. 4.

### DETAILED DESCRIPTION OF THE INVENTION

Hereinafter, preferred embodiments of the present invention will be described in detail with reference to accompanying drawings.

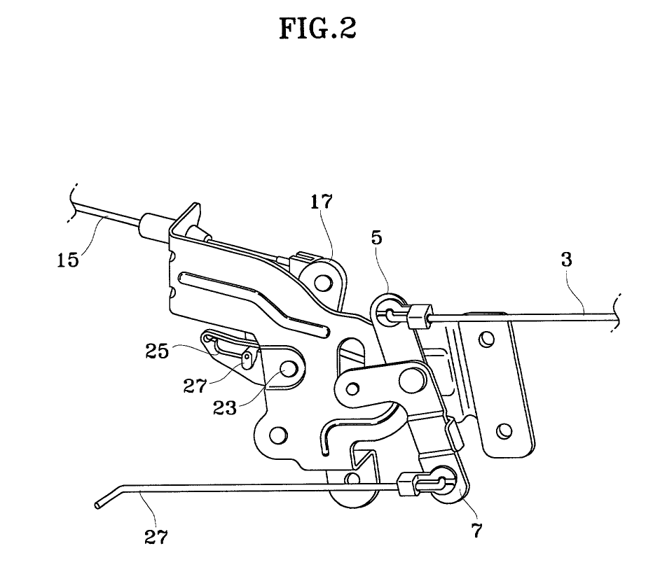

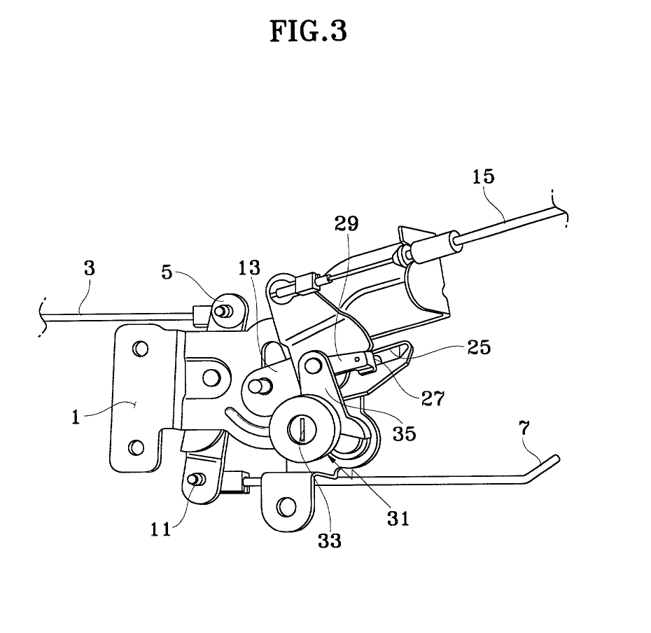

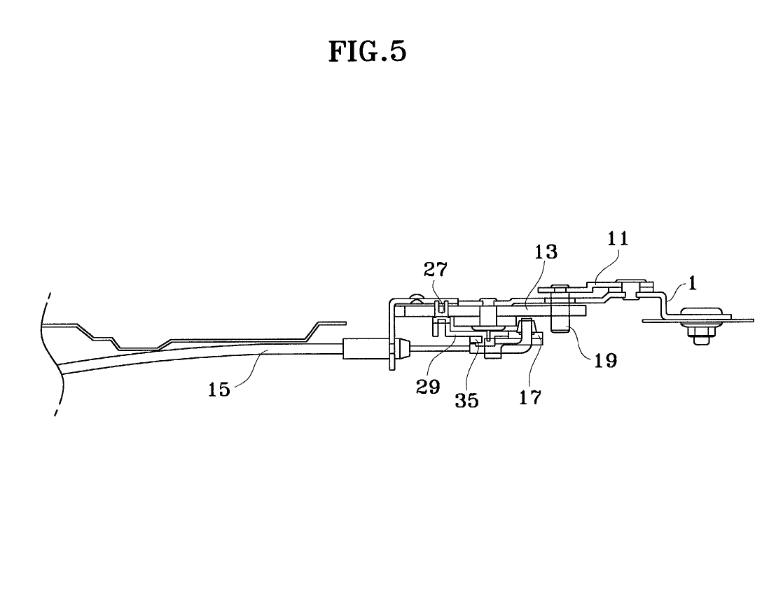

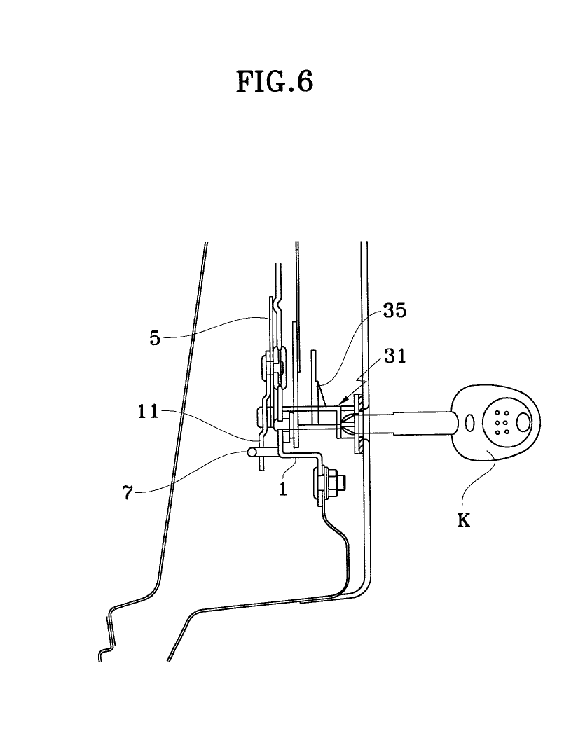

FIGS. 2 through 6 illustrate a tail gate locking apparatus for protecting children in accordance with the present invention.

As shown in the drawings, an outside lever 5 is installed at a base plate 1 coupled with a vehicle body, having an outside rod 3 connected to receive manipulation force from an outside handle (not shown). A latch lever 11 is rotatively installed at the base plate 1 to receive rotational force from the outside lever 5 and also connected with a latch device 9 by a latch rod 7. The latch lever 11 can be rotated regardless of the outside lever 5 to operate the latch device 9. When the outside lever 5 is rotated, the latch lever 11 is rotated to operate the latch device 9 by the outside lever 5 and also by another kind of operational force supplied thereto.

In other words, the latch device 9 can be operated by supplying operational force of the inside handle (not shown) by parts of a tail gate locking apparatus including: a control lever 13 rotatively installed at the base plate 1 to rotate the latch lever 11; an inside lever 17 rotatively installed at the base plate 1 with one side thereof being connected with an inside cable 15; and rotational force controlling means coupled between the control lever 13 and inside lever 17 to selectively switch a state of unblocking or blocking transmission of rotational force of the inside lever 17 to the control lever 13.

At this time, a connection pin 19 is positioned at the latch lever 11 for continuous rotations by the rotations of the control lever 13, and a long hole 21 is formed at the control lever 13 for easy transmission of the rotational force to the latch lever 11 without difficulty.

On the other hand, the inside lever 17 is coupled with a hinge 23 at the base plate 1 to allow for the same rotational axis as the control lever 13. The rotational force controlling means includes: a sliding groove 25 formed to the radius direction of the control lever 13; a sliding pin 27 to slide to be hitched at the sliding groove 25 for converting to the state of being hitched at the hitching protruder 18 of the inside lever 17; a pin rod 29 to fix the sliding pin 27; and a control linker 31 installed at the base plate 1 to be rotated with a key or driver for rotations of the pin rod 29, thereby selectively switching transmission of rotational state of the inside lever 17 to the control lever 13.

At this time, the control linker 31 has a key slot 33 for insertion of a key or driver, and a pin rod 29 is rotatively coupled at a lever part 35 protruded at one side of the control linker 31. As a result, the rotations of the control linker 31 allow the sliding pin 27 fixed at the pin rod 29 to slide at the sliding groove 25 of the control lever 13.

Operations of the apparatus of the present invention will be described as below.

If a tail gate is opened from outside of a vehicle, the manipulation force of the outside handle rotates the latch lever 11 through the outside lever 5 to enable the latch rod 7 connected with the latch lever 11 to operate the latch device 9, thereby unlocking the tail gate, in the same way as in the conventional method.

On the other hand, whether the tail gate can be opened from inside of the vehicle can be controlled in a predetermined method that a key or driver is inserted into the key slot 33 of the control linker 31 for rotations.

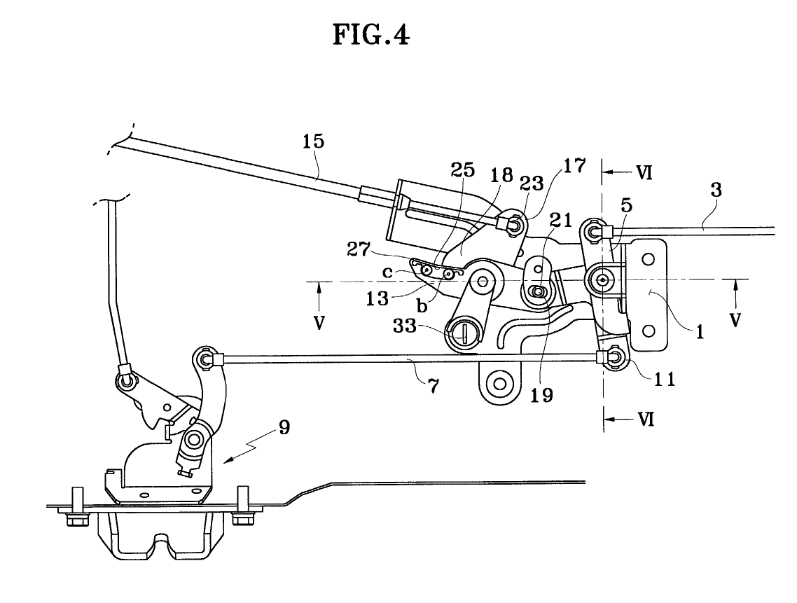

In other words, when the control linker 31 is rotated to make the sliding pin 27 connected thereto and fixed at the pin rod 29 get to position b of the sliding groove 25 of the control lever 11 (shown in FIG. 4), the control lever 13 gets rotated along with the rotated hitching protruder 18 of the inside lever 17. Then, the latch lever 11 is rotated to open the latch device 9, and the control linker 31 is rotated in reverse to make the sliding pin 27 of the pin rod 29 get to position c of the sliding groove 25. As a result, the hitching protruder 18 of the inside lever 17 does not get hitched by the sliding pin 27, but rotated to thereby fail to transmit the rotational force to the control lever 13. In other words, however hard the inside handle is manipulated from inside of the vehicle, the tail gate will not be open.

As described above, there is an advantage in the tail gate locking apparatus of the present invention in that the apparatus can be controlled to selectively switch a state of blocking or unblocking operations of the latch device to thereby prevent the tail gate from being dangerously opened by children's careless manipulation of the inside handle.

What is claimed is:

1. A tail gate locking apparatus for protecting children, apparatus comprising:
a base plate;
a latch lever rotatively installed at the base plate in connection to a latch device by a latch rod;
a control lever rotatively installed at the base plate to rotate the latch lever;
an inside lever rotatively installed at the base plate with one side thereof being connected with an inside cable; and
rotational force controlling means coupled between the control lever and inside lever to selectively switch a state of unblocking or blocking transmission of rotational force of the inside lever to the control lever.

2. The apparatus, as defined in claim 1, wherein the inside lever is coupled at the base plate with the same rotational axis as the control lever, and
the rotational force controlling means includes: a sliding groove formed to the radius direction of the control lever; a sliding pin to slide to be hitched at the sliding groove for converting to the state of being hitched at the hitching protruder of the inside lever; a pin rod to fix the sliding pin; and a control linker installed at the base plate to get rotated with a key or driver for rotations of the pin rod.
